(19) United States
(12) Patent Application Publication
(10) Pub. No.: US 2003/0222512 A1
(43) Pub. Date: Dec. 4, 2003

(54) Concepts and their applications, a motor which is driven by the magnetic field of the earth

(76) Inventor: Hanna Albert Awad, Ajaltoun (LB)

Correspondence Address: Hanna Albert Awad, 4721 Nathan West, Sterling Heights, MI, 48310, US

(21) Appl. No.: 10/260,684

(22) Filed: May 18, 2002

(51) Int. Cl. H02K 1/00

(52) U.S. Cl. 310/10

(57) ABSTRACT

Gravity is the attraction of two masses. (Between earth, air and body). It changes between day and night and altitudes.

Magnetism is a complex kind of centrifuge forces (Between electrons and nucleuses of nucleuses of different molecules). Different curves are withdrawn by electrons which lead to a centrifuge force.

A motor is fully explained in the invention which runs on the attraction of the south pole of a magnet and the north pole of earth and vice-versa and runs with minimum electricity input.

### CIRCUMSTANCES AND DATE OF CONCEPTION

Gravity is the attraction between two or more masses. The gravity on earth is the attraction between the mass of the body or the object and the mass of the earth plus the attraction between earth and air in atmosphere. That's why gravity changes with altitudes. Gravity also changes between day and night due to sun radiation that pushes.

Attraction between two masses is due to a complex kind of centrifuge forces. The spin of electrons and the turning of electrons around the nucleus produce the attraction between the two masses. If the two masses are spinning or moving around each other, It makes a very complex kind of centrifuge forces that is their attraction between each other. This is the theory that makes magnetism a centrifuge force between atoms and which in turn is a kind of gravity. So both gravity and magnetism are due to a complex kind of centrifuge forces which can be calculated.

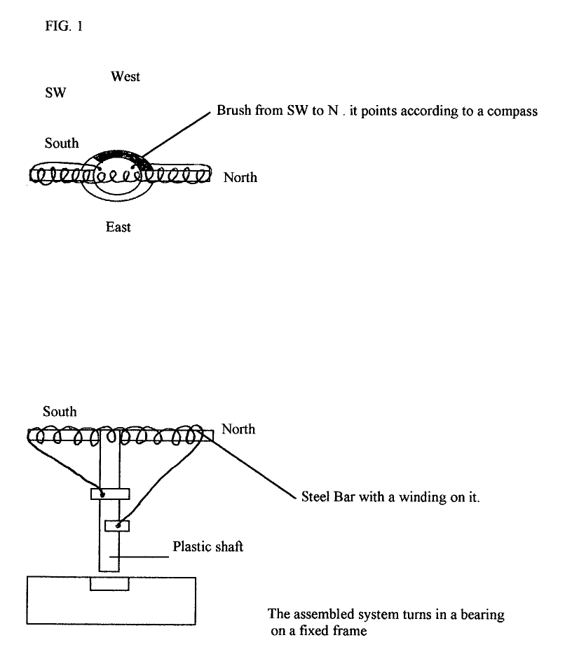

In 2000—I was thinking: a compass always points north. A compass is a relatively negligible magnet. What if we can put electricity on a winding around a steel bar (which will be a strong magnet) and make it turn on the field of the earth. When the steel bar points SouthWest we can establish contact, the magnet is on and it pushes North. It turns. When it gets to the north position, the winding losses contact. The magnet is OFF. Then the bar gained momentum and turns to SouthWest position where the current is again ON. and so on. FIG. 1.

DESCRIPTION OF THE INVENTION As shown in FIG. 1 below. It is a steel bar with a winding on it (to make it a magnet when current is on.) welded to a shaft of plastic (or any non-conductable shaft). The winding of the steel bar is connected to a point on the plastic shaft.

The brush extends from SouthWest to North. Another brush is needed for neutral, It may be all around the shaft. The steel bar and the shaft turns, when it gets to the position of SouthWest, connection with the brush is established and the current and the magnet are ON. it pushes north until the position of the steel bar is pointed North where it losses contact. Magnet OFF. But it gained momentum it turns until SouthWest again. And ETC . . .

The position of the brush must always be from SouthWest to north A compass can give the brush its position.

PURPOSE: to make a motor with very little energy consumption. In the motor described above, you have little energy consumption. The electricity gets on and off The same current merely comes and goes You will need less than the electricity needed for the rotor only in a conventional motor. (in a conventional motor the large power that drives the motor is on the stator

PARTS: brushes, winding, steel bar, plastic shaft and a compass.

USE: it could be used as a motor. A motor that drives everything even generators to produce more electricity than it is consumed.

NOVEL FEATURES: it's a new field in energy production which has not been explored until now.

ADVANTAGES: free energy production, power with little energy consumption.

TESTING RESULTS: I have assembled parts as shown in FIG. 1 and made a fixed brush with a fixed system which (the brush) extends from the position NorthWest to North. The system worked perfectly and it turned.

I claim:

1. The right for the design, production and sales of all motors and engines done by the attraction of the north and south poles of earth plus the one explained in the invention.
